(19) United States
(12) Patent Application Publication
(10) Pub. No.: US 2010/0105506 A1
(43) Pub. Date: Apr. 29, 2010

(54) HYDRAULIC TENSIONER FOR A POWER TRANSMISSION MEMBER HAVING TWO MODES OF OPERATION

(76) Inventor: Claude Rointru, St Etienne de Chigny (FR)

Correspondence Address: CLARK & BRODY, 1090 VERMONT AVENUE, NW, SUITE 250, WASHINGTON, DC, 20005, US

(21) Appl. No.: 12/605,506

(22) Filed: Oct. 26, 2009

Related U.S. Application Data
(60) Provisional application No. 61/193,082, filed on Oct. 27, 2008.

(51) Int. Cl. F16H 7/08

(52) U.S. Cl. 474/110

(57) ABSTRACT

The invention provides a linear hydraulic tensioner for a power transmission member having a first mode of operation with high forces and a second mode of operation with lower forces corresponding to continuous operation, wherein the tensioner comprises:
first and second mounting elements disposed at respective opposite bottom and top axial ends;
a tube secured to the first mounting element within which tube there slides a piston secured to the second mounting element;
a resilient sleeve surrounding the tube and the piston, being connected in leaktight manner to the first and second mounting elements and defining a low-pressure chamber for a hydraulic fluid;
a main prestress spring between the first and second mounting elements;
a first channel formed in the first mounting element to enable the low-pressure chamber and the inside of the tube to be put into communication, said channel being provided at its end that opens into the tube with a first shutter that is responsive to gravity; and
a second shutter element that is responsive to gravity and that is placed at one end of a second channel in the piston that opens out to the inside of the tube, said channel interconnecting a high-pressure chamber situated between the open ends of the first and second channels and a hydraulic fluid reservoir situated in the piston, the second shutter element being in a position for shutting said second channel when the tensioner is compressed.

### FIELD OF THE INVENTION

The invention relates to a linear hydraulic tensioner for a power transmission member having two modes of operation, and particularly, but not exclusively, for a reversible member capable of driving or of being driven, in particular a starter-alternator that is separate from the crankshaft of an engine and that is fitted with such a tensioner, and the invention also relates to a motor vehicle engine drive system, the system comprising in particular a starter-alternator and a crankshaft both fitted with transmission pulleys that are connected together by a belt that is tensioned by said tensioner.

The field of the invention is that of power transmission and it relates more particularly, but not exclusively, to reversible systems for driving a motor vehicle engine, in particular between a crankshaft and a starter-alternator interconnected by a resilient link such as a belt.

The invention may also be applied to any field requiring power transmission by rotary machines or motors, e.g. in industrial installations.

### BACKGROUND OF THE INVENTION

It is known for the starter function for an engine to be combined in the engine's alternator, which combined unit is then referred to as a starter-alternator. This combination makes it possible to omit a separate starter, a heavy toothed ring coupled to a high-inertial flywheel, and an electric starter.

A starter-alternator acts both as a driver for starting the engine via a flexible link, the crankshaft pulley then acting like a brake, and then as a driven member once the engine has started in order to recharge the battery (alternator function).

The starter-alternator may be coupled directly by being mounted on the crankshaft, then being referred to as an integrated starter-alternator (ISA), or it may be separate and placed in a belt transmission (replacing a conventional alternator), then referred to as a separate starter-alternator (SSA).

It is found that the integrated solution (ISA) prevents good adaptability on mounting/dismounting of the system, and above all gives rise to starting that is rough and uncontrolled.

The separate solution (SSA) with a belt drive between the two members, i.e. the crankshaft and the alternator, provides greater adaptability on mounting, and it also provides starting that is smoother. The belt is of the poly-V, cog, or trapezoidal type. The present invention, when applied to a starter-alternator, belongs to this category.

Starting an engine is a dynamic phenomenon that is rough and that fluctuates rapidly as a function of internal friction, which friction varies depending on the state of the connecting rods and the successive rises in compression.

During such a stage of starting under high stress, the speed of the crankshaft increases suddenly and the crankshaft torque goes from being driven to driving. Under such conditions, the torque on the starter-alternator also fluctuates, respectively from driving to driven.

After starting, under so-called “started” conditions, the crankshaft drives and the starter-alternator is driven. In this mode of operation, the instantaneous speed of the crankshaft then fluctuates in substantially sinusoidal manner: this phenomenon is referred to as engine acyclism. Such fluctuations in speed are transmitted by the belt to the driven members such as the alternator (here the starter-alternator operating in alternator mode), the compressor, and the water pump.

With a starter-alternator, since its moment of inertia is high, the generated dynamic torque presents high amplitudes in started mode, with positive and negative alternations even though rotation is in one direction only: these torques generate large variations in tension with maximum tension levels and high stresses for the components (belts, member ball-bearing tensioners, or winders) and low minimum tensions that can lead to poor drive (slip) and noise.

The two modes of operation may be defined as follows:

A) In engine starting mode, the torque that is to be developed by the starter-alternator in order to drive the crankshaft may reach values of about 90 newton meters (N·m) maximum. This makes it possible to drive crankshafts that present an opposing torque in the range 180N·m to 270 N·m (with a reduction ratio of 2 to 3).

A conventional starter is typically capable of delivering a driving torque of about 30 N·m maximum, thereby enabling it to deliver a maximum torque on the crankshaft of 90 N·m with a typical reduction ratio of 3 between those two members.

When torques significantly greater than those of a conventional alternator need to be delivered to the crankshaft, the variations in torque are large and the jolts then cause variations in the transmission via the belt, and also cause the belt to slip.

It is also appropriate to observe that the positive and negative torque values are not necessarily symmetrical, given the asymmetries of the damping effects (due to friction) and the mechanical asymmetries in the movements, both under starting conditions and under started conditions.

B) In started mode, the torque to be delivered is a combination:

of the dynamic torque generated by the inertia of the starter-alternator and by the acyclism of the engine; and

the electrical torque needed for generating electricity (alternator function).

In started mode, the torques to be transmitted are much smaller than in starting mode.

The two modes of operation are therefore very different.

The tensioner must be capable of handling both modes, by being made to operate differently in the two modes:
fast response with ability to deliver high levels of torque in starting mode, while maintaining sufficient minimum tension to limit slip of the belt and ensuring that the engine starts; and
limiting forces in started mode to a value that is sufficient to drive the accessories without belt slip and without excessively loading the belt and the bearings of the accessories.

Conventional hydraulic tensioners do not enable both modes to be handled simultaneously.

Two categories can be distinguished:

1) Systems that are Neither Controlled Nor Blocked

These provide:
either too little available force in starting mode, e.g. the device described in patent application FR 2 688 565 (Hutchinson);
or else too much force in started mode, e.g. the device described in patent U.S. Pat. No. 6,036,612 (NTN).
   2) Tensioners that are Controlled or with on/Off Blocking on Starting

These tensioners operate either by the tensioner being completely blocked during starting, so it behaves like a fixed tensioner, e.g. the tensioner described in PCT application WO 02/29287 (Gates Corp.), or else with the pressure of the damping fluid being controlled externally by means of an electrically-controlled servo-valve (e.g. as in PCT application WO 2006/053617 in the name of Ina-Schaeffler KG).

Controlled tensioners are very complicated and require external energy to be supplied in order to perform the control function. In addition, control logic needs to be implemented between an input signal (information concerning the speed and the load of the engine and/or the accessories) and the appropriate output signal (force/stroke of the tensioner).

### OBJECT AND SUMMARY OF THE INVENTION

An object of the invention is to avoid the above drawbacks at least in part by an independent component that does not require energy to be delivered thereto and that does not require external control, while being capable of working differently depending on the mode of operation.

The idea on which the invention is based is to incorporate a system with two shutter elements that are situated in a common chamber inside a linear hydraulic tensioner, thus also making it possible to satisfy potential constraints associated with limited available space.

The invention thus provides a linear hydraulic tensioner for a power transmission member having a first mode of operation with high forces and a second mode of operation with lower forces corresponding to continuous operation, wherein the tensioner comprises:
first and second mounting elements disposed at respective opposite bottom and top axial ends;
a tube secured to the first mounting element within which tube there slides a piston secured to the second mounting element;
a resilient sleeve surrounding the tube and the piston, being connected in leaktight manner to the first and second mounting elements and defining a low-pressure chamber for a hydraulic fluid;
a main prestress spring between the first and second mounting elements;
a first channel formed in the first mounting element to enable the low-pressure chamber and the inside of the tube to be put into communication, said channel being provided at its end that opens into the tube with a first shutter element that is responsive to gravity; and
a second shutter element that is responsive to gravity and that is placed at one end of a second channel in the piston that opens out to the inside of the tube, said channel interconnecting a high-pressure chamber situated between the open ends of the first and second channels and a hydraulic fluid reservoir situated in the piston, the second shutter element being in a position for shutting said second channel when the tensioner is compressed.

At least one shutter element may be a ball or a valve member (e.g. a shutter washer bearing against a seat), and its stroke may be limited by a stop.

The first and/or second shutter element may present a return spring urging it towards the open position.

The first mounting element may present a fastener element having a first endpiece mounted thereon, which first endpiece includes said first channel.

The first channel may include at least one radial first channel in communication firstly, at least one end with the low-pressure reservoir and secondly, with an axial first channel opening out to said first shutter element.

A cylindrical sheath may be placed facing the radial first channel(s), thereby avoiding producing an air/oil emulsion.

A second mounting element may present a fastener element having a second endpiece mounted thereon with the piston being mounted on said second endpiece.

The first and/or second endpiece may include a collar co-operating with a cup, one end of the resilient sleeve being housed between the collar and the cup, the collar and the cup being pressed against said end of the resilient sleeve by the force of the spring.

Since the end of the resilient sleeve is compressed in this way between the collar and the cup, the tensioner is sealed relative to the outside at this level.

### BRIEF DESCRIPTION OF THE DRAWINGS

Other characteristics and advantages of the invention appear better on reading the following description given by way of nonlimiting examples and with reference to the drawings, in which:

FIG. 1 is a section view of a tensioner in a preferred embodiment of the invention, in the non-mounted state;

FIG. 2 shows its state for an engine that is stopped;

FIG. 3 shows its state while the engine is being started by its starter-alternator;

FIG. 4 shows a relaxed state of the tensioner in started mode; and

FIG. 5 shows a variant of the invention in which the top shutter device is biased by a spring.

### MORE DETAILED DESCRIPTION

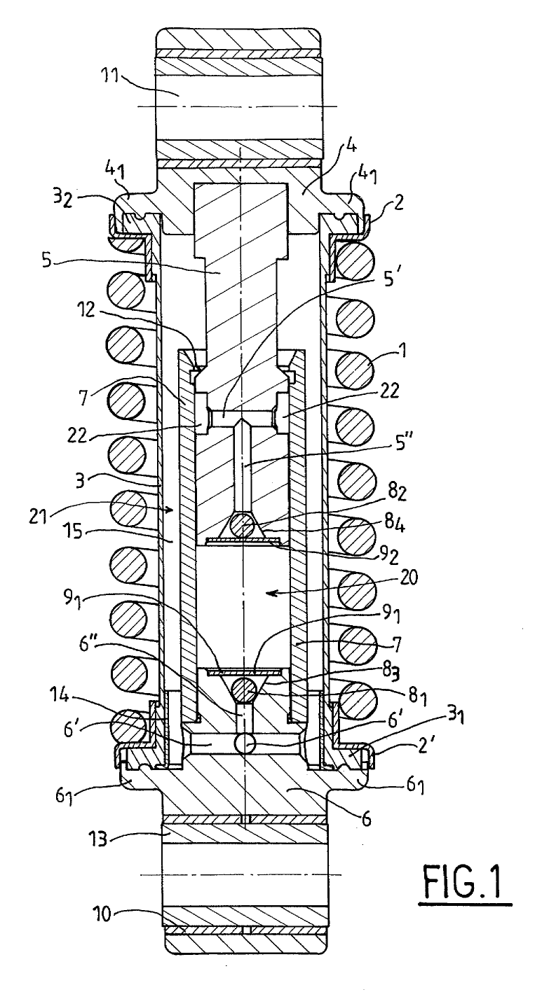

The tensioner shown in longitudinal section in FIG. 1 is for mounting in a vertical position (axis ZZ′ vertical) or inclined at an angle of not more than 40° to 45°.

The bottom mounting element 10, e.g. including an insert 13 bearing against a smooth bearing 13′, is for mounting beside the engine, while the top mounting element 11 presents a smooth bearing 11′ for receiving a hinged arm carrying a wheel that is used for tensioning the belt that connects a crankshaft pulley to a starter-alternator pulley.

The tensioner has a spring 1 of stiffness equal to 30 newtons per millimeter (N/mm), for example. In the mounted state, the tensioner is prestressed to limit the mounting stroke. The prestress is obtained by means of a clip 12 forming an abutment that prevents the piston 5 of the tensioner from moving upwards. By way of example, the prestress force is about 600 newtons (N).

A flexible sleeve 3, e.g. made of rubber, is mounted in leaktight manner and defines the external outline of a low-pressure reservoir 21 containing oil 15. The sleeve 3 is held rigidly via its end collars 3₁ and 3₂ against two endpieces 4 and 6 by shouldered cups 2 and 2′ resting on the plane faces of collars 4₁ and 6₁ of the endpieces 4 and 6. The cups 2 and 2′ are held pressing axially against the collars 3₁ and 3₂, which in turn press against the collars 4₁ and 6₁ by the compression force of the spring 1, thus serving to provide sealing.

A female endpiece 6 is rigidly secured to a ball-joint insert 13 by means of a screw (not shown) passing through the ball-joint insert 13 bearing against a smooth bearing 10 and clamped axially against the ball-joint insert 13. A male endpiece 4 is connected to a ball-joint insert 11 hinged by a screw (not shown) passing through the ball-joint insert 11 and clamped axially on the ball-joint insert 11.

A tube 7 is rigidly connected to the female endpiece 6. The female endpiece 6 has at least one radial channel 6′ communicating with the low-pressure reservoir 21 that extends between the tube 7 and the sleeve 3 and that is closed at its axial end by the endpieces 4 and 6. An anti-emulsion sheath 14 may be added in the passage for oil between the two parts 7 and 3.

An axial channel 6″ is provided in the female endpiece 6 and opens out into a seat 8₃, e.g. of frustoconical shape, on which there rests the bottom ball 8₁ under its own weight. The ball 8₁ cannot escape from the pressure chamber 20 situated on the inside of the tube 7 and defined by the top end of the endpiece 6, the bottom end of the piston 9, and the tube 7, because of a cap 9₁ that is secured to the female endpiece 6.

The piston 5 is rigidly connected to the male endpiece 4. The piston 5 has at least one radial channel 5′ communicating between the outside thereof and the inside of the tube 7. The radial channel 5′ opens out into an oil reservoir 22 housed in the tube 5 to return non-emulsioned oil to the axial channel 5″ during expansion by emptying the reservoir 22 completely or in part. In the example shown, the reservoir 22 forms an annular ring of external outline that is closed by the tube 7. An axial channel 5″ in the piston 5 is provided that opens out into a seat 8₄, e.g. of frustoconical shape, for the top ball 8₂. The ball 8₂ is situated in the high-pressure chamber 20, but cannot escape because of a cap 9₂ secured to the piston 5. In the rest position, the top ball 8₂ bears under its own weight against the cap 9₂.

Oil 15 can flow through the high and low channels 5′ & 5″ and 6′ & 6″, the high-pressure chamber 20, the low-pressure chamber 21, and the reservoir 22, in the manner that is described below.

In a preferred example of the invention, the diameter of the piston 5 is 12 millimeters (mm), the diameter of the top and bottom balls is 3.2 mm, and the diameter of the top and bottom axial channels 5″ and 6″ is 2 mm. This dimensioning is explained below, and it will be understood that the dimensions may be different for the top and bottom elements.

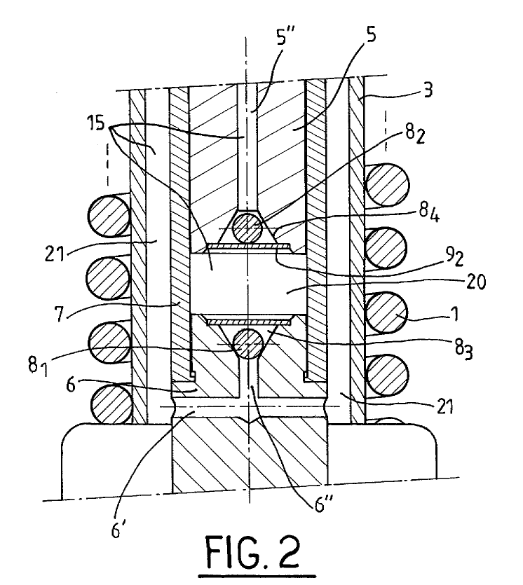

The operation of the FIG. 1 tensioner is explained below with reference to FIGS. 2 to 4.

In these figures, the tensioner is shown in the mounted state, in which the piston 5 has moved down towards the female endpiece 6, being disengaged from the prestressed abutment 12, thereby tensioning the belt.

The tensioner is generally delivered held in a pre-mounting position in which the tensioner is in a minimum facing position. For mounting purposes, the prestress is released and the tensioner expands so as to occupy the position shown in FIG. 2. In a variant, the tensioner may be compressed manually from the FIG. 1 position. At low speed, oil passes without difficulty through the shutter devices 8₁ and 8₂.

In the rest state, shown in FIG. 2, the bottom ball 8₁ bears against its seat 8₃ and closes the oil passage. The top ball 9₁ rests under gravity against the cap 9₂ and the oil passage is open.

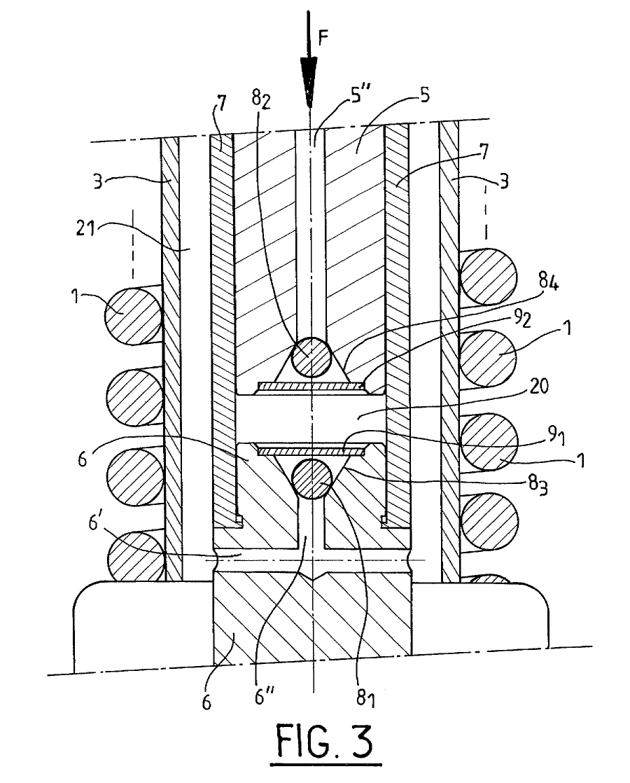

On starting (FIG. 3), compression occurs in the tensioner (torque rises), and the piston 5 moves down very fast into the chamber 20. The top ball 8₂ rises against the seat 8₄ and closes the end of the channel 5″ that opens into the high-pressure chamber 20 while the bottom ball 8₁ remains pressed against its seat 8₃.

This results in a strong rise of pressure delivering a large rise of force as is needed to tension the belt on starting and prevent it from slipping. It should be observed that during this starting stage, alternation may occur in the torque signal and the tensioner may also find itself in the relaxed position (see relaxed mode below), but the inventors have found that during this starting stage, the mean travel speed of the tensioner remains quite low, for a length of time that is long enough to ensure that the top ball 8₂ continues to remain in the closed position and to ensure that the leaks associated with clearance between the piston 5 and the tube 7, in particular, take place over an identical long period of time. This rather long closure time leads to a large increase in force since both shutter devices 8₁ and 8₂ are in the closed position. That is the desired effect.

In the started state, the large variations in torque become smaller and the tensioner is stressed merely by dynamic variations, some of which are produced by the acyclism of the engine. Under such conditions of alternating stresses of small stroke, the two shutter devices 8₁ and 8₂ move in alternation. Their movement depends on the movement of the piston 5. It should be observed that the amplitude of the movement of the piston 5 under such circumstances is of the order of 1 mm to 5 mm, thus making it possible for the reservoir 22 to be dimensioned so that its capacity is equal to or greater than the volume of oil that is moved. Two circumstances can then be distinguished:

### A) Compression Direction

The bottom closure device (ball 8₁) is closed and the top closure device (ball 8₂) rises against its seat 8₄ to stop fluid passing through the channel 5″.

Under conditions of normal operation, two possible circumstances can be distinguished:

a) The top orifice (frustoconical seat 8₄) is not completely obstructed by the top device 8₂ (e.g. because of little or very little acyclism). The acyclical acceleration is small enough to avoid closing the top shutter device 8₂ completely. A mere throttling effect is observed on the oil passing through the top orifice, giving the extra force needed for operation in started mode.

b) The top device 8₂ is closed (e.g. with strongly acyclism), but during a very short period of time with opening and closing alternating at high frequency (FIG. 3). The pressure rise is reduced by the frequency of alternation of the signal that passes quickly into decompression/expansion. In spite of the obstruction, the level of force remains well below the level reached in starting mode.

Under extreme conditions, i.e. certain circumstances of sudden variation in tension in started mode (engine near to stalling, an incident due to untimely blocking of an accessory, etc. . . . ), the tensioner reacts by closing both shutter devices 8₁ and 8₂ completely, thereby producing a larger force for limiting variation in belt tension.

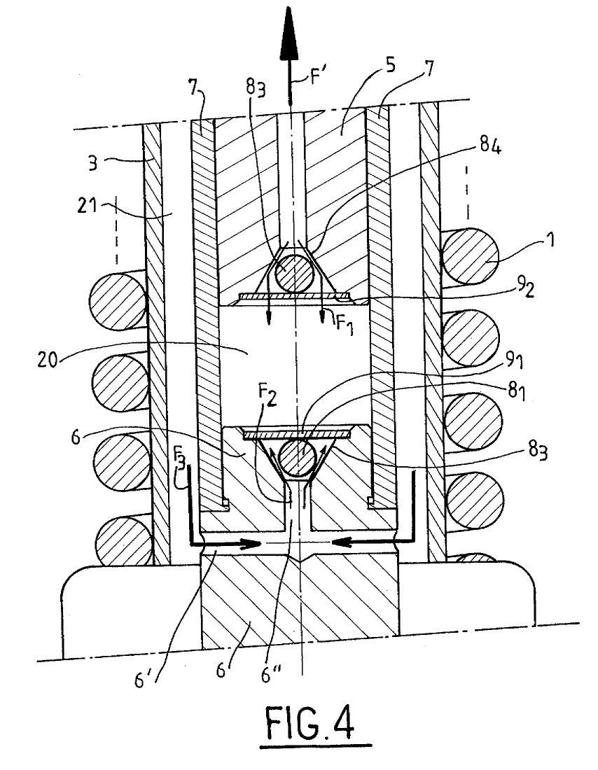

### B) Expansion Direction FIG. 4 (Elongation)

During movement of the piston 5 in the direction of arrow F′, both shutter devices 8₁ and 8₂ are in the open position.

The pumping effect sucks the bottom shutter device 8₁ upwards, thereby releasing the bottom orifice (frustoconical seat 8₃), and the top shutter device 8₂ drops downwards, thereby releasing the top orifice 8₄. Opening the shutter device 8₁ enables the high-pressure chamber 20 to be resupplied with the oil it needs. This resupply takes place in the direction of arrows F₁ to F₃ from the channels 5″, 6″ and 6′ emptying the reservoir 22 in part. For maximum effectiveness, the high-pressure chamber 20 needs to be permanently full of oil 15. The presence of air is very harmful to proper operation of the tensioner (random damping).

It should be observed that in the open state of the two shutter devices 8₁ and 8₂ while the piston 5 is rising, the tensioner operates essentially on the stiffness of the spring 1 (ignoring oil friction) and the tension in the belt is in its minimum state necessary for operation.

### Adaptation and Possible Adjustments

Adjustment is for use in started mode. As explained above, it is not desirable while in started mode for the top device 8₂ to be closed in the compression direction for too long while the bottom device 8₁ is closed, since that would give rise to forces that are too great and of no use. It is possible to adapt the closure response of the top device (8₂, 8₄) in started mode.

To do this, action is taken on the inertia of the ball. Two adjustable parameters are available:

a) Mass of the ball: this is essentially a function of the diameter of the ball since the materials used are generally steels; to slow down closure, mass is increased, and vice versa.

b) Closure stroke (between the rest position and the closed position) in order to give rise to a delay, the stroke is lengthened by acting on the position of the cap 9₂.

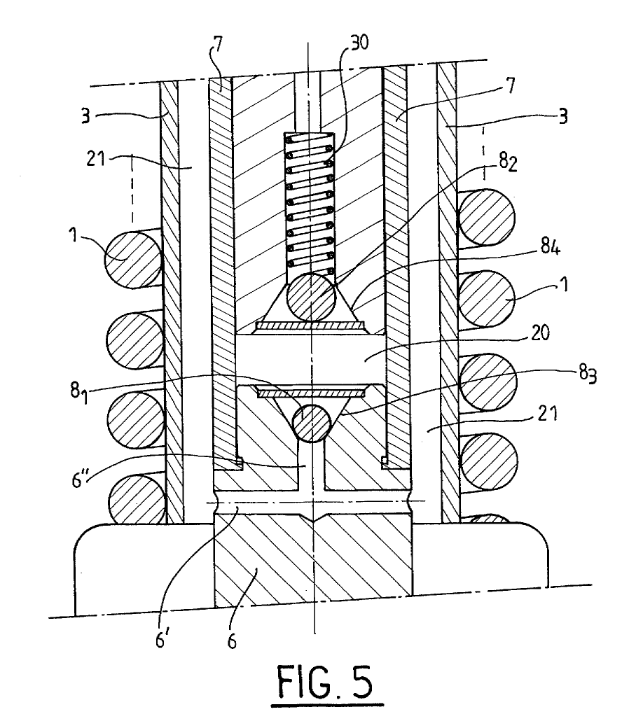

An additional adjustment parameter consists in adding a return spring 30 to the top closure device 8₂ (see FIG. 5) exerting an additional force that needs to be overcome in order to achieve closure and facilitating opening in the expansion direction. This is more expensive, but it may be appropriate if adjustments using the first two parameters are not sufficient.

### Bottom Adjustment: Improving Opening and Filling

The bottom valve member may be modified, e.g. by adding a spring (not shown) so as to be normally open. Closure of the bottom valve member 8₁, 8₃ in the compression direction of the tensioner is then retarded by the force to be overcome prior to closing. Thereafter, the top device 8₂ can close.

The advantage of this device for adjustment acting on the bottom valve member appears in the relaxation direction. In the relaxation direction, the spring can facilitate opening of the bottom device 8₁. This can be thought of as advance opening enabling filling to take place more quickly.

What is claimed is:

1. A linear hydraulic tensioner for a power transmission member having a first mode of operation with high forces and a second mode of operation with lower forces corresponding to continuous operation, wherein the tensioner comprises:
first and second mounting elements disposed at respective opposite bottom and top axial ends;
a tube secured to the first mounting element within which tube there slides a piston secured to the second mounting element;
a resilient sleeve surrounding the tube and the piston, being connected in leaktight manner to the first and second mounting elements and defining a low-pressure chamber for a hydraulic fluid;
a main prestress spring between the first and second mounting elements;
a first channel formed in the first mounting element to enable the low-pressure chamber and the inside of the tube to be put into communication, said channel being provided at its end that opens into the tube with a first shutter that is responsive to gravity; and
a second shutter element that is responsive to gravity and that is placed at one end of a second channel in the piston that opens out to the inside of the tube, said channel interconnecting a high-pressure chamber situated between the open ends of the first and second channels and a hydraulic fluid reservoir situated in the piston, the second shutter element being in a position for shutting said second channel when the tensioner is compressed.

2. A tensioner according to claim 1, wherein at least one shutter element comprises a ball.

3. A tensioner according to claim 1, wherein at least one shutter element comprises a valve member.

4. A tensioner according to claim 2, wherein the stroke of the ball or of the valve member is limited by an abutment.

5. A tensioner according to claim 1, wherein the first and/or second shutter element presents a return spring urging it towards the open position.

6. A tensioner according to claim 1, wherein the first mounting element presents a fastener element having a first endpiece mounted thereon, which first endpiece includes said first channel.

7. A tensioner according to claim 6, wherein the first channel includes at least one radial first channel in communication firstly, at least one end with the low-pressure reservoir and secondly, with an axial first channel opening out to said first shutter element.

8. A tensioner according to claim 6, wherein the first endpiece includes a first collar co-operating with a first cup, a first end of the resilient sleeve being housed between the first collar and the first cup, the first collar and the first cup being pressed against the first end of the resilient sleeve by the force of the main spring.

9. A tensioner according to claim 8, wherein a cylindrical sheath is disposed facing the radial first channel(s).

10. A tensioner according to claim 1, wherein the second mounting element presents a fastener element having a second endpiece mounted thereon, said piston being mounted on said second mounting endpiece.

11. A tensioner according to claim 10, wherein the second endpiece includes a second collar co-operating with a second cup, a second end of the resilient sleeve being housed between the second collar and the second cup, the second collar and the second cup being pressed against the second end of the resilient sleeve by the force of the main spring.
